(19) United States
(12) Patent Application Publication
(10) Pub. No.: US 2014/0107819 A1
(43) Pub. Date: Apr. 17, 2014

(54) Inverse Probability Bracket

(71) Applicant: Brandon McCoy Reid, Greensboro, NC (US)

(72) Inventor: Brandon McCoy Reid, Greensboro, NC (US)

(21) Appl. No.: 13/651,489

(22) Filed: Oct. 15, 2012

(51) Int. Cl. G06N 7/00

(52) U.S. Cl. CPC G06N 7/005
USPC 700/93

(57) ABSTRACT

The Inverse Probability Bracket method is a technique of making and scoring “Pick-Em” bracket competitions by using weighted scores in a way that awards correctly predicting unlikely events. The system “weights” the correct picks in the competition according to the unlikelihood of those selections. Points are awarded based on the inverse of the likelihood of the event occurring.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

The Inverse Probability Bracket applies to any bracket system for games or sports where participants are asked to project the winning teams. This is often referred to as “filling out a bracket” or participating in a “Pick-Em” game or pool. The invention is designed specifically with the NCAA Men's Basketball Division I Tournament in mind. As such, in the two examples of an Inverse Probability Bracket explained below, I base my analysis on the NCAA Men's Basketball Division I Tournament brackets from the years 1985-2012, which can be found archived online at www.allbrackets.com. However, the system can also be used for other events.

### SUMMARY OF THE INVENTION

Most brackets on sports websites or other pools award points to participants who correctly predict the winning teams on a flat basis each round (e.g. 1 point for correctly predicting a first-round winner, 2 points for correctly predicting a second-round winner, etc.). To my knowledge, no bracket competition (a competition where projections for the whole tournament are made at the beginning) exists that has a system for awarding bonuses on the basis of predicting particularly unlikely game results. The Inverse Probability Bracket differs, because it awards points on a weighted scale by giving points based on the inverse of the likelihood of correctly picking a certain result. Correctly picking an unlikely outcome is calculated in a way that yields a higher point score than correctly picking a likely result.

### BRIEF DESCRIPTION OF THE SEVERAL VIEWS OF THE DRAWING

FIG. 1. Historical Performance Table. Based on the NCAA Men's Basketball Division I Tournament, years 1985-2012. As a first step in ascertaining the likelihood of each team's performance, each seed's historical totals are computed using:

Total=1*(First Round Victories)+1*(Second Round Victories)+2*(Third Round Victories)+4*(Third Round Victories)+8*(Fourth Round Victories)+16*(Semifinal Victories)+32*(Championship Victories)

with 0.5 subtracted from the first seed's point total and added to the 16 seed's total to prevent division by 0. (This 0.5 transfer would be removed if a 16-seed ever defeats a 1-seed and therefore develops real historical data on which to base projections.)

FIG. 2. Point Calculation Total by Seed for NCAA Men's Basketball Division I Tournament. the number of additional points awarded for correctly picking a team to advance to the next round is shown for our inverse probability example. For instance, correctly picking a particular 7-seed to win the championship results in 1.818+5.535+6.808+17.455+31.616+63.232=126.465 points. The high point total reflects the fact that this is a highly unlikely event. Note that the 16-seed point total is not based on historical data, since no 16-seed has won its matchup against a 1-seed; therefore the 16-seed point total could be adjusted if the present values are deemed unreasonable.

FIG. 3. NCAA Men's Basketball Division I Tournament, 2012 bracket. These are the actual results of the 2012 NCAA Men's Basketball Division I Tournament. Results and all historical data were obtained from http://www.allbrackets.com.

FIG. 4. Sample Participant Bracket, 2012 NCAA Men's Basketball Division I Tournament. Participants are awarded points based on the correct picks they fill out based on the table in FIG. 2. In this case, the participant's final score is 55.798 total points. Correct picks are highlighted in green; incorrect ones are highlighted in red. Points for each prediction are listed under each pick.

### DETAILED DESCRIPTION OF THE INVENTION

The idea behind the “inverse probability” bracket is to have a tournament “pick-em” bracket that awards points to someone's predictions based on the likelihood that the teams they pick will perform well. The following will suffice as a simple example of an inverse probability bracket.

The most basic “inverse probability bracket” is simply to award points on pure historical performance. Probabilities are estimated through raw historical data. For instance, in the NCAA Division I Men's Basketball Tournament, in matchups in 1985-2012, 7-seeds have won 66 out of 112, or a proportion of 0.589286, of their first-round matchups with 10-seeds, leaving 10-seeds with the other 0.410714. A point system that uses “inverse probability” with probabilities assigned from historical data awards 1/.589286=1.697 points for correctly picking a 7-seed to win and 1/.410714=2.435 points for correctly picking the 10-seed to win the game. For the second round, 7-seeds have made it to the Sweet Sixteen 19 out of 112 possible times, so the probability is estimated as the historical proportion of 0.169643. Inverse probability awards 1/0.169643−1.697=5.895−1.697=4.198 points for correctly picking the second game being won by the 7-seed (where 1.697 is subtracted since those points have already been incorporated into the first round game; the point total is therefore based on the chance that a 7-seed had of winning the first two rounds without prior knowledge of whether or not the first round was won. This process continues throughout the bracket.

This method leaves problems that need to be addressed. Small sample size limits the reliability of the data used in these calculations. For instance, since 1985 (the year the historical data being used begins), there have been no 7 seeds to reach the final four in the NCAA Men's Basketball Division I Tournament and no 5-seeds to win the championship, but clearly the probability of these events is not zero. No 16-seeds have advanced past the first round. Something must be done to account for these “zero-proportion” historical examples with nonzero probabilities. I have developed another inverse probability bracket that addresses this issue.

This second bracket example takes into account the performance of each seed in the NCAA Basketball Men's Division I tournament since 1985. Historical performance among the seeds is measured by taking a weighted sum of each seed's victories as follows:

Total=1*(First Round Victories)+1*(Second Round Victories)+2*(Third Round Victories)+4*(Third Round Victories)+8*(Fourth Round Victories)+16*(Semifinal Victories)+32*(Championship Victories)

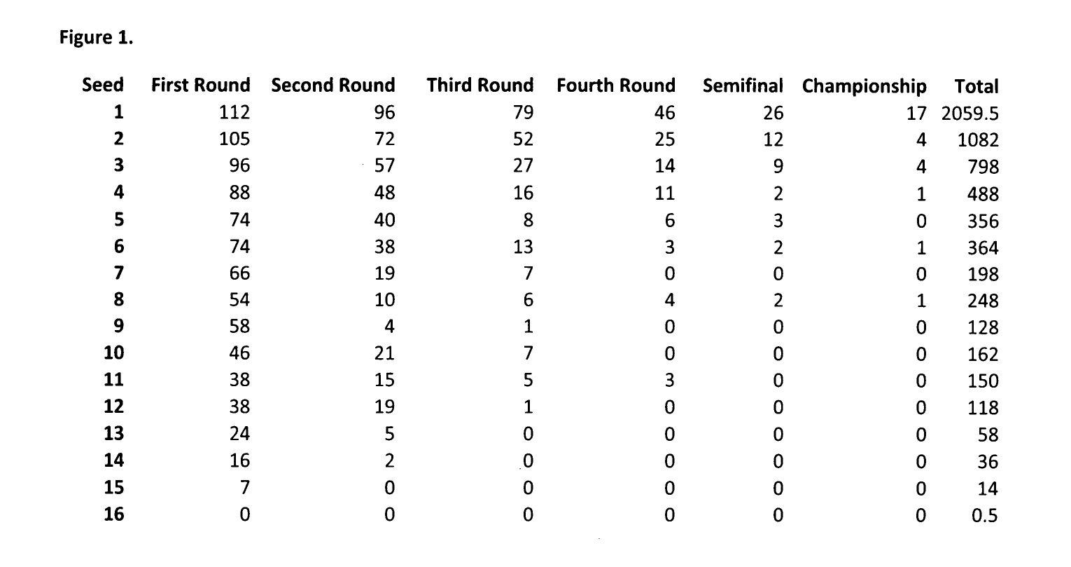

Note that total points in each round is proportional to the number of teams that were competing for those points. For instance, getting to the “Sweet 16” entails winning two games, so 1*(1 First Round Victory)+1*(1 Second Round Victory)=2 points, which 4 teams in any particular section of the bracket were competing for. An entry to the Final 4, however, gives 1+1+2+4=8 points, which 16 teams competed for. Thus, point allocation is proportional to the number of teams vying for a slot. Using this system, the historical point totals are computed for each seed (FIG. 1).

Now, once a participant's “Prediction Bracket” has been filled out, points are awarded for correct picks as follows. “Estimated probability” that any given team will advance to any particular place on the bracket is computed as the Total column (for that seed) divided by the sum of the Total column for all teams that would have been eligible to advance to that place in the bracket at the beginning of the tournament. For example, in a first-round matchup between a 7-seed and a 10-seed, since 7-seeds have 198 historical points to the 162 historical points of 10-seeds, correctly picking a 7-seed to advance yields 1/(198/360)=1.818 points, where 198 is the historical total of 7-seeds and 360 is the “total point pool” of the seeds competing for that slot in the bracket (198+162). Similarly, correctly picking the 10-seed to advance yields 1/(162/360)=2.222 points.

For the second round, picking the 7-seed to advance correctly yields 1/(198/1456)−1/(198/360)=5.535 points, where 198, again, is the total historical points of the 7-seeds, and 1082+198+162+14=1456 is “the total point pool” of all the teams competing for that slot in the bracket (the 1082, 198, 162, and 14 belong to the 2-seed, 7-seed, 10-seed, and 15-seed, respectively, since those are the seeds vying for that position in the bracket). Like the simple Inverse Probability Bracket example in Paragraph [0008], a number is subtracted (1/(198/360) in this case) to account for points already awarded in previous rounds.

This process continues all the way to the championship, with participants awarded points based on inverse probability methods to each slot in the bracket that is correctly predicted. A sum is taken of all the points a participant is awarded (0 points for incorrect predictions plus the points for correct predictions as described above) to arrive at a final score for each participant.

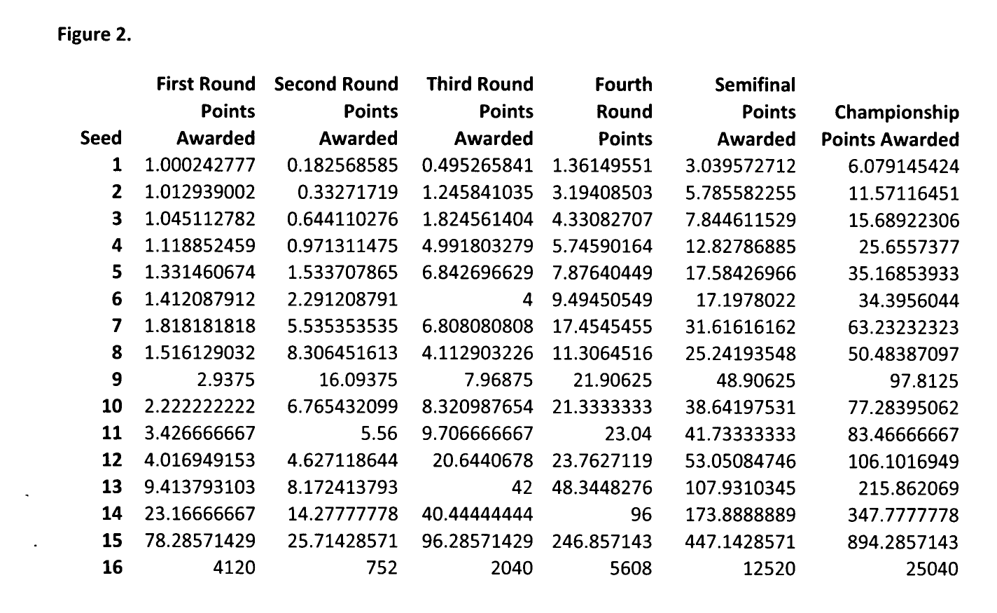

A table has been included (FIG. 2) to show the number of points awarded for correctly advancing a team, based on the team's seed, to each round under this system. Note that the “total point pool” described above doubles for the semifinals and again for the championship, because 2 teams of each seed (two 1-seeds, two 2-seeds, two 3-seeds, etc.) are vying for each championship slot and all four of each seed, for every seed, is vying for the slot of National Champion.

Furthermore, an example has been included to show how to calculate the number of points a sample bracket receives using the actual 2012 NCAA Men's Basketball Division I Tournament as an example.

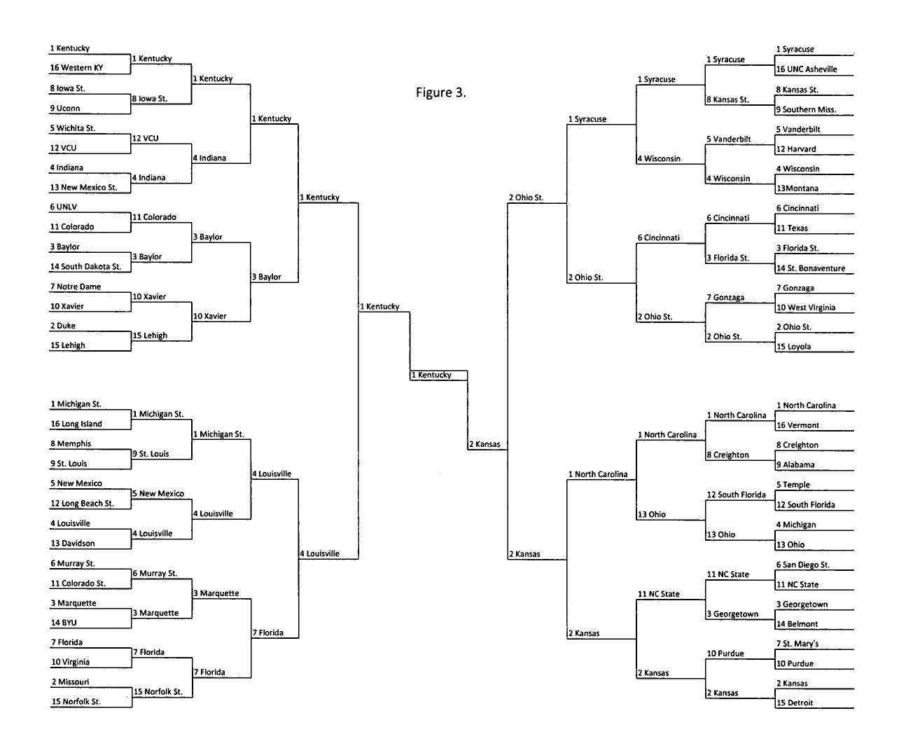

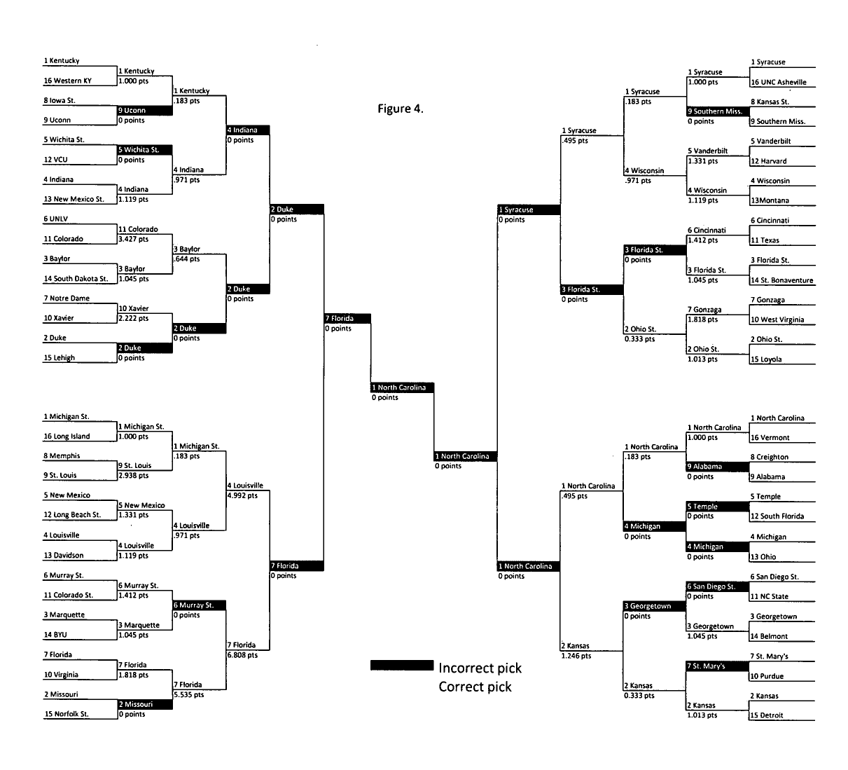

FIG. 3 is the actual results of the 2012 NCAA Men's Basketball Division I Tournament and FIG. 4 is a sample bracket for 2012 with point tallies based on a sample participant in a bracket pool for that tournament.

1. The Inverse Probability Bracket is any scoring method for “pick-em” bracket competitions where the points awarded for correct picks are awarded based on the inverse of the probability of a given team/player winning (noting that “probability” as defined here does not refer strictly to the true probability of an event, but could be the likelihood as calculated by a number of different ways, such as historical statistics or other methods of analysis).
